(19) United States
(12) Patent Application Publication
(10) Pub. No.: US 2012/0098837 A1
(43) Pub. Date: Apr. 26, 2012

(54) APPARATUS FOR AUGMENTING A HANDHELD DEVICE

(75) Inventors: Thomas Steven HULBERT, London (GB); Durrell Grant Bevington Bishop, London (GB)

(73) Assignee: Luckybite LLP, London (GB)

(21) Appl. No.: 13/277,306

(22) Filed: Oct. 20, 2011

Related U.S. Application Data
(60) Provisional application No. 61/394,940, filed on Oct. 20, 2010.

(51) Int. Cl. G06T 13/00

(52) U.S. Cl. 345/473

(57) ABSTRACT

Apparatus and system that enables a handheld multimedia device (e.g. an mp3 player, such as the Apple™ iPod™ Touch, or a mobile telephone, such as the Apple™ iPhone™, or any other device that includes one or more multimedia technologies such as a display screen, touch input, video, audio and networking capabilities) to be adapted, both in software and physically, so as to be used for a new or enhanced purpose.

### CROSS-REFERENCE TO RELATED APPLICATIONS

This application is based on and claims priority to U.S. Provisional Application No. 61/394,940, filed Oct. 20, 2010, the entire contents of which are hereby fully incorporated herein by reference.

### BACKGROUND OF THE INVENTION

There are many and varied types of products that benefit from the use of a colour display screen, multimedia capabilities such as video and audio, or sensor inputs such as accelerometers.

However, due to manufacturing constrains and expense, particularly when considering entertainment products such as toys and games, it is often not possible to utilize such technologies.

Further, many people own and use portable handheld devices with colour display screens and multimedia capabilities but use them for a relatively limited set of uses and, although it is possible to adapt such devices within software (by installing additional applications and so forth), there are limited possibilities to adapt such devices physically.

Existing solutions that relate to the problems outlined above are:
Multimedia enhancing peripherals for mobile devices, such as amplified speaker docks for mp3 players.
Cases for mobile devices that have some fashionable or entertaining design but which are passive and do not relate to the function of the device.

### SUMMARY OF THE INVENTION

Apparatus and system that enables a handheld multimedia device (e.g. an mp3 player, such as the Apple™ iPod™ Touch, or a mobile telephone, such as the Apple™ iPhone™, or any other device that includes one or more multimedia technologies such as a display screen, touch input, video, audio and networking capabilities) to be adapted, both in software and physically, so as to be used for a new or enhanced purpose.

The intention is to augment an existing handheld device by using a software application combined with an additional physical element, so as to enable the device to be used for a new purpose—the additional physical element containing, attaching to or otherwise integrating with the handheld device and having an intrinsic relationship to features of the device (e.g. cut-outs that enable only certain areas of the screen to be visible) so as to appear to transform the device into a new product. The additional physical element may be constructed from various materials, such as papers, cards, plastics, rubbers, fabrics and so on, and may have various physical designs and graphics applied.

For example, a software application and a stuffed-fabric cover could be provided to adapt a handheld device into an animated soft-toy—the application being installed on the handheld device and the device being inserted into the stuffed-fabric cover. Such an example embodiment would combine the handheld device, application and cover in an integrated way so as to appear to transform the device into a new product, and therefore the cover may relate to and integrate with various features of the handheld device (e.g. a cover in the form of an animal's face may have cut-outs to enable areas of the screen of the device to be visible so as to display content that relates to the cover, such as a pair of animated eyes).

### BRIEF DESCRIPTION OF THE DRAWINGS

FIG. 1 is an example embodiment of the invention for application as an animated soft-toy.

FIG. 2 shows the elements of the example embodiment shown in FIG. 1 combined to illustrate the embodiment in use.

FIG. 3 shows the user interacting with the example embodiment shown in FIG. 1.

FIG. 4 shows some further possible enhancements of the example embodiment shown in FIG. 1.

### DETAILED DESCRIPTION

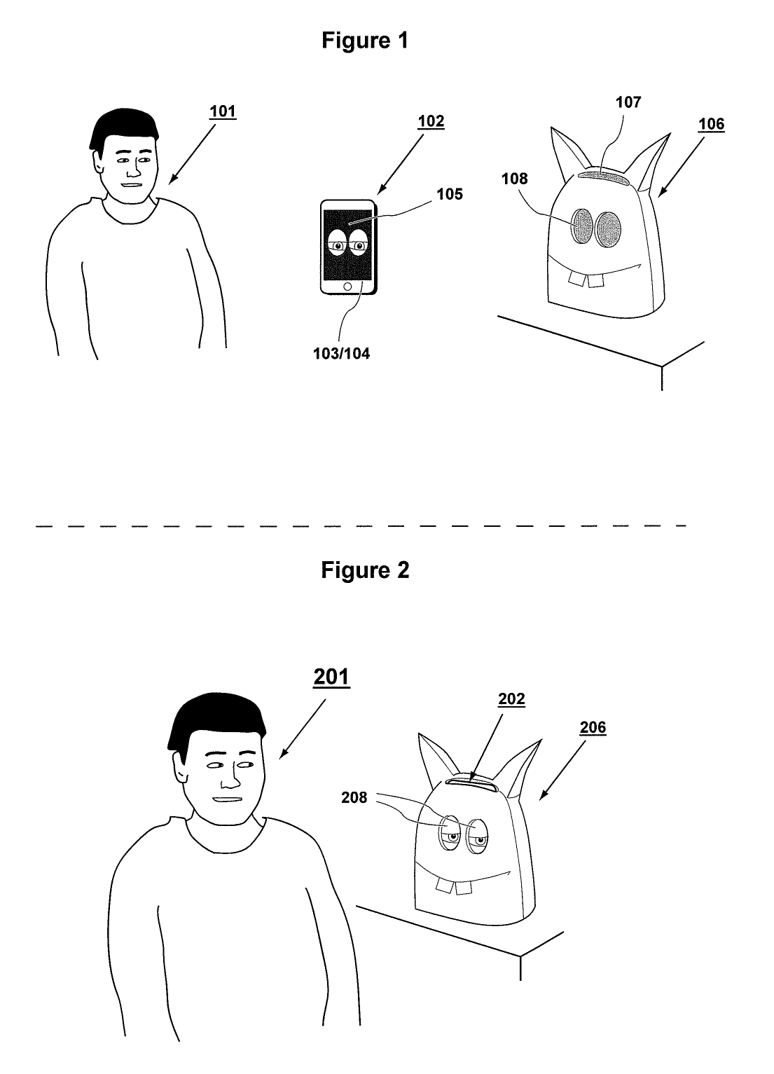

The apparatus incorporates, but is not limited to, three main elements—a handheld multimedia device, such as an mp3 player, mobile telephone, PDA or similar device; a software application (which is installed on the device); and a physical element that contains, attaches to or otherwise integrates with the handheld device. All three elements combine to augment the handheld device, adapting it for a new purpose, whereby the device appears to be transformed into a new product. FIG. 1 shows an example embodiment of the apparatus.

In the preferred embodiment, the handheld device is incorporated into the additional physical element in such a way that the physical element and features of the device (such as the display) become intrinsically related and therefore the content output from the software application (e.g. in the form of video and audio) interplays with the physical element so as to appear to transform the device into a new product. For example, the handheld device may be inserted into a stuffed-fabric cover in the shape of an animal's face in such a way that the display of the device aligns with cut-out areas on the cover, so that animated eyes (generated from the software application) are visible through the cut-out areas and therefore the animal face appears to have “real” animated eyes (see the soft-toy example embodiment in FIG. 1).

In most embodiments, the apparatus may utilize various technologies that may be available on the handheld device (such as a video display output, touch display input, audio, networking, GPS, accelerometer sensors, tilt/orientation sensors, microphone) so as to enhance the purpose for which the device is being adapted. For example, it may utilize the touch display input of the device to respond to user interaction (such as an eye blinking when a user touches the eye with his finger, as in the case of a soft-toy similar to the example embodiment shown in FIG. 1); or it may use the tilt/orientation sensors of the device to automatically align content displayed on the screen of the device with graphics printed on the physical element.

In some embodiments, the additional physical element will integrate with the device in a more ‘active’ way, whereby a technological relationship between the device and the physical element is created, rather than the physical element merely containing or attaching to the device, so as to enhance the overall functionality or interactivity. For example, the physical element may contain a cable and dock type connector to enable it to be connected to the device and for the device to be charged via the physical element; or the physical element may contain a dock type connector and a speaker so as to amplify the sound from the device; or the physical element may contain a dock type connector and sensors (e.g. switches, potentiometers, capacitive sensors, microphones, IR receivers, LDRs, FSRs and so on) so that interaction with the physical element results in communication from the physical element to the device via the dock connector causing the software application to respond in some way; or the physical element may contain a dock type connector and actuators (e.g. motors, solenoids, servos, wheels and so on) so that the software application can control the actuators via the dock connector (e.g. in an example embodiment where the physical element is in the form of a robot with wheels which drives around and is controlled from the software application); or the physical element may contain areas of material that when touching the touch display of the device cause the device to register a touch input, and therefore when a user presses certain corresponding areas of the physical element the material thus comes into contact with the touch display causing a touch input to registered and the software application to respond in some way.

In some embodiments the software application may output content that is up-to-date or enhanced, either by prompting the installation of new version of the application from time to time (or an alternative but related additional application); or by loading or streaming content from a remote source using the networking capabilities of the handheld device.

The present invention may be applied to many alternative configurations, and used in many varied applications, some examples include:
1. A Soft-Toy, where the handheld device, software application and physical element are combined to make a soft-toy that appears animated (e.g. the handheld device is inserted into a stuffed fabric cover in the form of an animal's face which has circular cut-outs that enable areas of the display of the device to be visible so as to show an animation of eyes moving).
2. A Radio or “Hi-fi”, where the handheld device is electrically connected to the physical element (e.g. a plastic case in the form of a Radio or “Hi-fi”) and where the handheld device, software application and physical element are combined to play digital and/or internet radio stations or audio files, such as mp3s, which are amplified via speakers in the physical element (e.g. the handheld device is inserted into a plastic case in the form of a Radio which has a dock connector, speaker and cut-outs that enable areas of the display of the device to be visible so as to show graphics that mimic the interface of a Radio and which enable the selection and control of internet radio stations, which are then played back via the speaker in the case).
3. An Alarm Clock, where the handheld device, software application and physical element are combined to display the time and output audible alarms and where the physical element is an appropriate form to allow the clock to be placed on a surface or hung on a wall or otherwise be easily viewed (e.g. the handheld device is inserted into a plastic box which has cut-outs that enable areas of the display of the device to be visible so as to display the time and which is also a suitable form to be placed on a bed-side table, enabling the time to be easily viewed).
4. A Board Game Accessory, where the handheld device, software application and physical element are combined to create video/audio output that enhances the game play (e.g. to enhance a board game with the theme of Battleships, the handheld device is inserted into a plastic case in the form of a submarine's instrument panel which has cut-outs that enable areas of the display of the device to be visible so as to display a sonar image).
5. A Cushion, where the handheld device, software application and physical element are combined to make a cushion that appears animated (e.g. the handheld device is inserted into a cushion which has circular cut-outs that enable areas of the display of the device to be visible so as to show an animation of eyes moving).
6. A Printed Card Promoting a Film, where the handheld device, software application and physical element are combined to create a printed film promotion which presents video/audio content relating to a film and where the card is printed with graphics representing characters or scenes from the film or other similar graphics relating to the film (e.g. the handheld device is attached to the back side of a printed card which includes on its front side graphics representing a character from a children's animated film and which has a cut-out that enables an area of the display of the device to be visible so as to display the face of the character so that the character on the printed card appears to be animated and begins to speak, enacting dialog from the film for example).
7. A Cuckoo Clock, where the handheld device, software application and physical element are combined to make a “bird house” which appears to have an animated bird inside (e.g. the handheld device is inserted into a box constructed from printed shaped cardboard sections joined together which when assembled give the appearance of a “bird house”, and which has a circular cut-out in the front face that enables an area of the display of the device to be visible so as to show an animation of a bird, the bird appearing to “Cuckoo” at certain times of the day which is also accompanied by audio of the bird's sound played from the device).
8. A Viewing Device, where the handheld device, software application and physical element are combined to make a monocular or binocular eye piece which when viewed shows visual imagery (e.g. the handheld device is inserted into a plastic case with monocular eye piece protruding from the case and which has a circular cut-out on the interior of the case that enable an area of the display of the device to be visible so as to show images that appear magnified, such as planets in the night sky—such images could alternatively appear 3D if the appropriate optics where included within the eye piece and the images on the display of the device was rendered in such a way to create a 3D effect when viewed through the optics).
10. A Retro Appliance, where the handheld device, software application and physical element are combined to make an appliance that appears animated and which may produce video or audio which is typically associated with that appliance (e.g. the handheld device is inserted into a box constructed from printed shaped cardboard sections joined together which when assembled give the appearance of a cassette tape Walkman™, and which has a cut-out in the front face that enables an area of the display of the device to be visible so as to show an animation of a cassette tape spoiling which is accompanied by music being played from the handheld device).

A scenario of use is described below, representing one such embodiment of the invention in more detail: The example embodiment is described with reference to the figures.

### Detailed Description—Example Embodiment (Animated Soft-Toy)

FIG. 1

User 101 has a handheld multimedia device 102 (containing a software application 105); and a physical element 106.

Device 102 includes a video display 103, touch input 104, and a software application 105 (which has been installed on the device and is intended to be used in combination with the physical element 106).

Physical element 106 is a stuffed fabric cover in the form of an animal's face which includes an internal space 107, into which the handheld device 102 is to be inserted and thus supported, and two cut-out areas 108, which align with the display screen of the device (when the device is inserted into the physical element) and enable two areas of the device display to be visible.

When running on the device, software application 105 displays a pair of animated eyes on the screen of the device, which become visible through the cut-out areas in the physical element when the device is inserted into the physical element. Application 105 also responds to touch input so that when the device display is touched within the area of the screen displaying the eyes, the eyes will be animated so as to appear to blink in response to the touch.

FIG. 2

User 201 has launched the software application (105 in FIG. 1) on multimedia handheld device 202, and has inserted the device into the physical element 206. The cut-out areas 208 on the physical element align with the display of the device 202. The software application displays a pair of animated eyes, which are visible though the cut-outs 208 and therefore appear to be the eyes of the animal's face (the physical element 206). Thus, the handheld device, software application and physical element have been combined to transform the device into a new product, an animated soft-toy.

In a further enhancement of this embodiment, the software application (105 in FIG. 1) on the multimedia handheld device 202 outputs sound by playing audio files stored locally on the device or by streaming audio files from a remote location via a network connection. The sound may be audio content that relates to the physical element 206 and the overall context of use. For example, the sound could be a narrated story where the dialog appears to be spoken by the soft-toy, the voice being appropriate to the character of the soft-toy. Further, sensors in the device 202 could be utilized by the software application to enable the user to control the sound playback (i.e. play, pause, stop etc.) by interacting with the soft-toy. For example, an accelerometer in device may be utilized so that when the soft-toy is tilted the sound playback is controlled (e.g. the user tilts the soft-toy backward to stop the sound, tilts it forward to play the sound, tilts it left to go to the previous sound, and tilts it right to go to the next sound). Other examples of interaction that make use of motion/orientation sensors such as an accelerometer could include ‘shake up and down’, ‘shake left and right’, ‘tilt left and keep down’, ‘tilt right and keep down’, ‘tilt back and keep down’, ‘tilt forward and keep down’, ‘momentary tilt left and then return to upright’, ‘momentary tilt right and then return to upright’, ‘hold upside down’.

In a further enhancement of this embodiment, the software application on the multimedia handheld device 202 receives or loads new content via a network connection. This new content may be loaded into the software application free of charge to the user, or the user may purchase this new content via the software application. Examples of new content that could be loaded into the software application are: new audio content (e.g. the latest episode of an audio story that the soft-toy will narrate to the user); new graphical content (e.g. the user may be able to customise the appearance of the soft-toy by updating the colour of the eyes); new game content (e.g. different games each week could be loaded into the software application so that the user would be able to interact with the soft-toy in different ways).

In a further enhancement of this embodiment, the software application on the multimedia handheld device 202 utilizes the camera of the device (e.g. a front facing or rear facing video camera typically used for taking photos or recording video or videotelephony) to recognize three-dimensional objects (e.g. identifiable colours or forms) or two-dimensional graphics (e.g. identifiable machine readable printed codes such as 2D barcodes or other recognizable printed patterns), the lens of the camera being unobstructed by means of an appropriately positioned cut-out in the physical element 206. The soft-toy would thus be able to indentify objects and print material in its environment and would react by means of audio/visual output. For example, stickers with illustrated pictures and 2D barcodes printed on them could be placed around a room so that when the soft-toy is carried around the room the soft-toy could “see” and recognize each sticker (i.e. the software application would read the 2D barcodes via the camera on the device) and thus play back different sounds associated with each sticker, such as the voice of the toy describing the illustrated picture on a sticker or telling the user additional information about the picture.

In a further enhancement of this embodiment, the software application on the multimedia handheld device 202 utilizes the microphone of the device to either record audio or to analyze audio input so as to allow the user to interact with the soft-toy using sound. For example, the soft-toy could appear to mimic the user by repeating what the user says by recording the users voice and then playing it back with distortion or audio filtering so that that it appears to be the voice of the toy. Further, the software application could analyze audio input from the microphone so as to identify particular frequencies and/or sounds that it has been programmed to respond to and thus react by means of audio/visual output. For example, the soft-toy could “listen” (i.e. the software application analyzes sound input via the microphone on the device) for certain notes to be played on a toy piano and respond by singing a lyric whilst also animating its eye in time to the music.

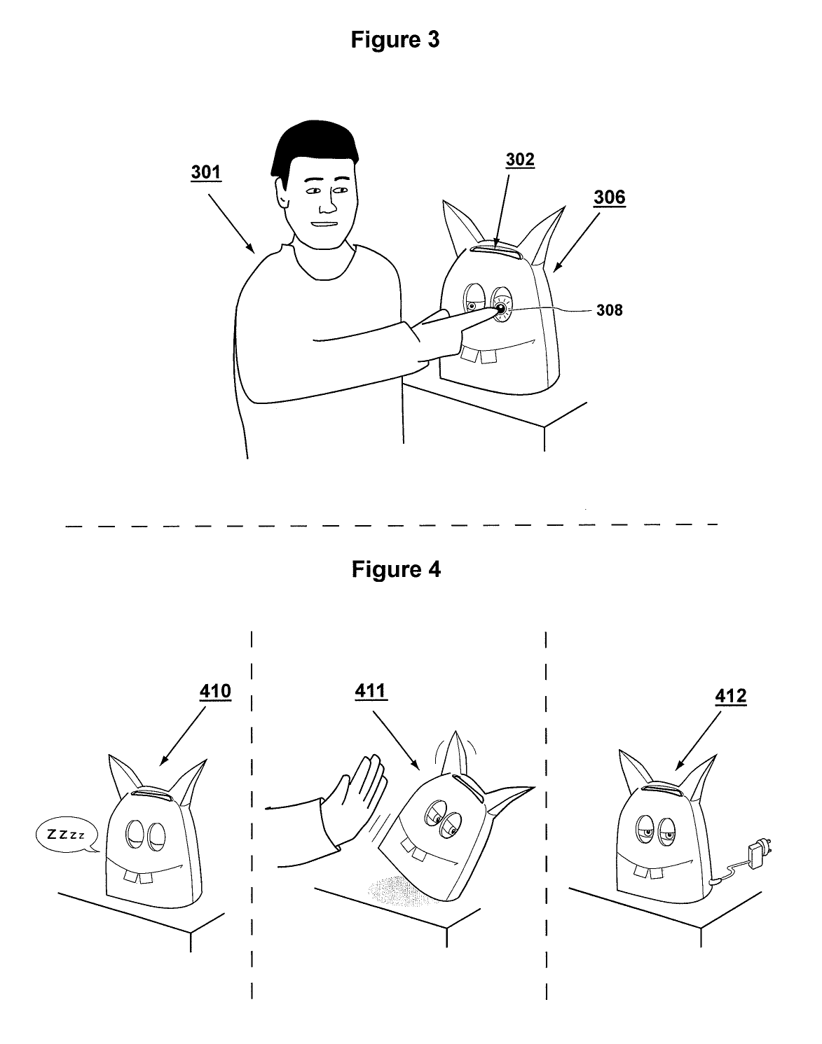

FIG. 3

User 301 inserts his finger through the cut-out 308 in physical element 306 and touches the display of handheld device 302. The device registers a touch input and in response the software application animates the eye so as to make the eye appear to blink. Thus the soft-toy becomes interactive, blinking when it is touched or “poked” in the eye.

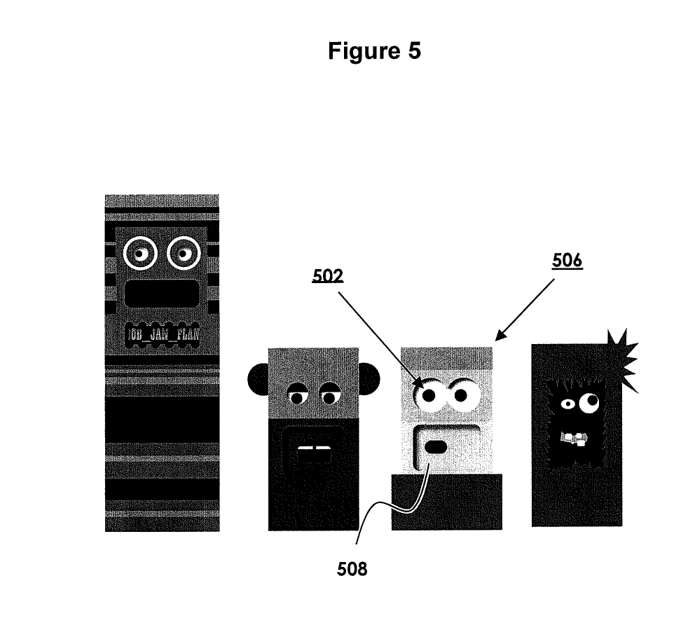

FIG. 4

Further enhancements of this embodiment may be to utilize the date/time features of the device to make the soft-toy 410 appears to sleep at appropriate times (e.g. close the animated eyes on screen when it becomes evening); to utilize the accelerometer sensors in the device so that when the soft-toy 411 is shaken or tilted the eyes appear dizzy or dazed (e.g. the animated eyes may spin or become “crossed”); or the physical element may include an external cable and a dock type connector within the internal space (107 in FIG. 1) to which the handheld device would be connected, enabling the device to be powered and charged via the soft-toy 412.

So, in use, a user receives a software application and a physical element (a soft-toy in the form of an animal face). He installs and runs the software application on his handheld multimedia device and inserts the device into the physical element. The software application displays a pair of animated eyes, which are visible through two cut-outs in the physical element. The soft-toy thus appears to “come to life”, having a pair of animated eyes. If the user inserts his finger through one of the cut-outs and touches the display screen, the “eye” blinks, thus the soft-toy also becomes interactive.

The soft-toy embodiment of the invention referred to in FIGS. 1 to 4 may be used in a number of different ways (many of which require only selecting a different software application on the handheld device or changing the ‘mode’ from within one software application), some examples include:
1. A “Chattering Character”, where audio playback from the soft-toy would appear to be the characters voice and may include anecdotes, monologues, “chit-chat” or jokes and where the animation of the eyes could relate to the audio.
2. A “Story Teller”, where audio playback in the form of stories (e.g. audio books or Podcasts) from the soft-toy would appear to be narrated by the toy and where playback of the stories could be controlled via physical interaction with the toy (e.g. play, pause, fast-forward) and where the animation of the eyes could relate to the interaction or audio (e.g. open wide when a scary moment happens in the story); the audio being played either from files stored locally within the software application, or via an accessible audio library stored locally on the device but not specific to the application (e.g. the media library of the iPhone™), or files stored remotely and streamed from a remote location (e.g. a web server on the internet).
3. A “Disk Jockey”, where audio playback in the form of music tracks from the soft-toy would appear to be output from an additional miniature turntable used by the toy and where playback of the music could be controlled via physical interaction with the toy (e.g. play, pause, next-track) and where the animation of the eyes could relate to the audio (e.g. bounce in time to the music); the audio being played either from files stored locally within the software application, or via an accessible music library stored locally on the device but not specific to the application (e.g. the media library of the iPhone™), or files stored remotely and streamed from a remote location (e.g. a web server on the internet). The soft-toy may also voice over the music (e.g. to introduce the next song or tell the user some information about the song).
4. A “Radio Presenter”, where audio playback in the form of live radio from the soft-toy would appear to presented by the toy; the audio being streamed live from a remote location (e.g. a web server on the internet).
5. A “Musical Instrument Toy”, where motion/orientation sensors in the device, such as an accelerometer, could be used to map different physical movements of and interactions with the toy to different sound samples and effects. Backing music could also be output from the toy, so that the generated sound samples and effects could be mixed over audio tracks, and where the animation of the eyes could relate to the audio or physical interaction (e.g. spin around when the toy is tilted); the audio being played either from files stored locally within the software application, or via an accessible music library stored locally on the device but not specific to the application (e.g. the media library of the iPhone™), or files stored remotely and streamed from a remote location (e.g. a web server on the internet).
6. A “Stand-Up Comedian”, where audio playback from the soft-toy would appear to be the characters voice and may include anecdotes or jokes and where the animation of the eyes could relate to the audio.
7. A “Copy-Cat Character”, where the voice of the user is recorded and then played back from the soft-toy with distortion or effects applied, so as to appear to be the characters voice repeating what the user has said.
8. A “Buddy Toy”, where two characters are designed to work with each other and where audio playback from each soft-toy would appear to be that character's voice and would relate to the audio of the other character (e.g. each character would have the dialog for one half of a conversation and so when used as a pair would appear to talk to each other).
9. A “Remote Controller”, where sensors in the device, such as an accelerometer, could be used to map different physical interactions with the toy to different types of input to a second device, such as a personal computer or video games console; whereby the soft-toy becomes a controller for content (e.g. games, photos, music etc.) on the second device, the handheld device in the toy communicating with the second device via a wired (e.g. USB) or wireless (e.g. Wi-Fi, Bluetooth, Zigbee) connection.
10. A “Quiz Master”, where audio playback from the soft-toy would appear to be the toys voice, the audio being questions which the user is intended to answer; the user being able give their answer by physically interacting with the toy in some way (e.g. the physical element of the soft-toy may have areas of material that when pressed cause the inside surface to touch the touch display of the handheld device and cause an input to be registered by the software).
11. A “Teacher Character”, where audio playback from the soft-toy would appear to be the characters voice and may include explanations of certain educational subjects or questions that the user is intended to answer, and where the animation of the eyes could relate to the audio and interaction (e.g. the eyes could open wide if the answer given by the user was wrong).

FIG. 5

FIG. 5 shows an alternative example of this embodiment, where the toy is part of a series or collection of characters, each having unique characteristics (e.g. different voices output as audio from the handheld device or different graphics 508 on the display of the device 502 relating to physical element 506 for each character). Each character could be a soft toy or could be a plastic/vinyl/rubber toy or could be made from printed card (as in the illustration in FIG. 5).

According to one aspect of the invention, there is provided an apparatus comprising a hand-held device and a container, the container including a window or cut-out, the hand-held device including a screen, the hand-held device being removable from the container, the hand-held device arranged in the container such that some or all of the screen is exposed through the window, the hand-held device running a software application that provides screen content which relates to the design or function of the container.

The apparatus may be one in which the container is a toy.

The apparatus may be one in which the container is a soft toy.

The apparatus may be one in which the software application makes the toy or soft toy appear animated.

The apparatus may be one in which the software application generates audio output from the hand-held device.

The apparatus may be one in which only some of the screen is exposed through the window or cut-out.

The apparatus may be one in which less than half of the screen is exposed through the window or cut-out.

The apparatus may be one in which software applications can be purchased from an application store.

The apparatus may be one in which video or audio content can be purchased from a vendor using the hand-held device.

The apparatus may be one in which the camera of the hand-held device is used to recognize three-dimensional objects or two-dimensional printed patterns, such as 2D barcodes.

The apparatus may be one in which the microphone of the hand-held device is used to record audio (e.g. the user's voice) or to analyze audio input (e.g. to detect tones).

1. Apparatus for augmenting an existing handheld computing device running a software application, the apparatus including an additional physical element containing, attaching to or otherwise integrating with the handheld device and having an intrinsic relationship to the handheld device and the software application running on the device, so as to enable the device to be used for a new or enhanced purpose.

2. Apparatus as claim 1 whereby the handheld device, software application installed on the device and additional physical element combine to augment the handheld device in such a way that the device appears to be transformed into a new product.

3. Apparatus as in claim 1 where the handheld device is a portable multimedia device, which includes a video display and audio and video capabilities, such as an mp3 player, mobile telephone, smartphone, PDA or similar device.

4. Apparatus as in claim 1 whereby the handheld device is integrated into the additional physical element in such a way that the physical element and features of the device become intrinsically related and therefore the output from the software application interrelates with the physical element.

5. Apparatus as in claim 1 whereby the physical element contains the handheld device and has one or more cut-out areas which enable areas of the display on the device to be visible so as to create an in intrinsic relationship between the physical element and the device and therefore cause video content output from the software application to interrelate with the physical element.

6. Apparatus as claim 1 where the physical element has a physical form that relates to the content of the software application.

7. Apparatus as in claim 1 where the physical element has graphics applied to it that relate to the content of the software application.

8. Apparatus as in claim 1 which utilizes one or more of the technologies that may be available on the handheld device (such as a video display output, touch display input, audio, networking, GPS, accelerometer sensors, tilt/orientation sensors, microphone) so as to enhance the purpose for which the device is being augmented.

9. Apparatus as in claim 1 where the additional physical element integrates with the handheld device in such as way that a technological relationship between the device and the physical element is created so as to enhance the overall functionality or interactivity of the apparatus.

10. Apparatus as in claim 9 where the technological relationship is an electrical connection between the handheld device and the physical element for the purpose of transmitting power or communication signals.

11. Apparatus as in claim 10 where the physical element includes a dock type connector, to enable it to be electrically connected to the handheld device, and a speaker so as to amplify the sound from the handheld device.

12. Apparatus as in claim 10 where the physical element includes a dock type connector, to enable it to be electrically connected to the handheld device, and sensors (e.g. switches, potentiometers, capacitive sensors, microphones, IR receivers, LDRs, FSRs and so on) so that interaction with the physical element results in communication from the physical element to the device via the dock connector causing the software application to respond in some way.

13. Apparatus as in claim 9 where the technological relationship is a touch input transmitted from the physical element to the touch display of the handheld device whereby the physical element contains sections of material that when touching the touch display of the device cause the device to register a touch input, thus causing the software application to respond in some way.

14. Apparatus as in claim 1 where the software application may output content that is up-to-date or enhanced by loading or streaming content from a remote source using the networking capabilities of the handheld device.

15. Apparatus as in claim 1, which is used as a Soft-Toy, where the handheld device, software application and physical element are combined to make a soft toy that appears animated.

16. Apparatus as in claim 1, which is used as a Radio, where the handheld device is electrically connected to the physical element and where the handheld device, software application and physical element are combined to make a product that appears to be a radio which plays digital and/or internet radio stations output from the handheld device that are amplified via speakers in the physical element.

17. Apparatus as in claim 1, which is used as a “Hi-fi”, where the handheld device is electrically connected to the physical element and where the handheld device, software application and physical element are combined to make a product that appears to be a hi-fi which plays music files, such as mp3 files, output from the handheld device that are amplified via speakers in the physical element.

18. Apparatus as in claim 1, which is used as an Alarm Clock, where the handheld device, software application and physical element are combined to display the time and output audible alarms and where the physical element is an appropriate form to allow the clock to be placed on a surface or hung on a wall or otherwise be easily viewed.

19. Apparatus as in claim 1, which is used as a Board Game Accessory, where the handheld device, software application and physical element are combined to create a physical prop with video/audio output that enhances the game play.

20. Apparatus as in claim 1, which is used as a Printed Card Promoting a Film, where the handheld device, software application and physical element are combined to create a printed film promotion which presents video/audio content relating to a film and where the card is printed with graphics representing characters or scenes from the film or other similar graphics relating to the film.

21. Apparatus as in claim 1, which is used as a Viewing Device, where the handheld device, software application and physical element are combined to make a monocular or binocular eye piece which when viewed shows visual imagery.

22. Apparatus of claim 15, in which the handheld device outputs sound by playing audio files stored locally on the device or by streaming audio files from a remote location via a network connection and where the sound is a narrated story where the dialog appears to be spoken by the soft-toy, the voice being appropriate to the character of the soft-toy.

23. Apparatus of claim 22, in which sensors in the device are utilized by the software application to enable the user to control the sound playback (i.e. play, pause, stop etc.) by interacting with the soft-toy.

24. Apparatus comprising a container, suitable for a hand-held computing device, the container including a window or cut-out, the hand-held device including a screen, the hand-held device being removable from the container, the hand-held device arranged in the container such that some or all of the screen is exposed through the window, the hand-held device running a software application that provides screen content which relates to the design or function of the container.

25. Apparatus of claim 24 in which the container is a toy.

26. Apparatus of claim 24 in which the camera of the hand-held device is used to recognize three-dimensional objects or two-dimensional printed patterns such as 2D barcodes.

27. Apparatus of claim 24 in which the microphone of the hand-held device is used to record audio (e.g. the user's voice) or to analyze audio input (e.g. to detect tones).

28. A software application suitable for a hand-held computing device, the application designed to be used in conjunction with an additional physical element containing, attaching to or otherwise integrating with the handheld device and having an intrinsic relationship to the handheld device and the software application running on the device, so as to enable the device to be used for a new or enhanced purpose.
